(19) United States
(12) Patent Application Publication
(10) Pub. No.: US 2026/0197331 A1
(43) Pub. Date: Jul. 9, 2026

(54) ANOMALY DETECTION USING GRAPH NEURAL NETWORKS

(71) Applicant: Walmart Apollo, LLC, Bentonville, AR (US)

(72) Inventors: Nishanth Domakonda, Nallagandla (IN); Raviteja Uppalapati, San Francisco, CA (US); Rajat Gupta, Bengaluru (IN); Arup Kumar Das, Bengaluru (IN); Srinivas Kotamraju, San Jose, CA (US); Akash Sheoran, Bengaluru (IN); Samrat Kokkula, Sunnyvale, CA (US); Arun Menon, Varthur (IN); Prashanth Rao R V, Bangalore (IN); Jitesh Chandra Mishra, Bengaluru (IN); Nitish Ranjan Sahoo, Bengaluru (IN)

(21) Appl. No.: 19/014,088

(22) Filed: Jan. 8, 2025

(51) Int. Cl. H04L 9/40; G06N 3/042

(52) U.S. Cl. CPC H04L 63/1425; G06N 3/042; H04L 63/1441

(57) ABSTRACT

Example implementations relate to detecting a terminated entity in a network environment. A network activity dataset including data representative of network activity within a network environment and a plurality of data records is received. Each data record in the plurality of data records includes a set of attributes. A graph that links systems having a first role in the data representative of network activity and a subset of the plurality of data records is generated. Feature information from the set of attributes for one or more data records in the subset of the plurality of data records in the graph is aggregated. A machine learning model is trained based on the aggregated feature information derived from the graph. Using the trained model, a determination representing a likelihood that a respective system having the first role in the data representative of network activity is linked to the terminated entity is generated.

### TECHNICAL FIELD

This application relates generally to automated risk detection, and more particularly, to automated risk detection in network environments.

### BACKGROUND

Users of a network environment who engage in behavior that does not meet standards of the network environment (e.g., risky, dishonest, fraudulent behavior) may be terminated to safeguard other legitimate users of the network environment. Some previously terminated users attempt to regain access to the network environment by masquerading as a new user.

### BRIEF DESCRIPTION OF THE DRAWINGS

Various examples will be described below with reference to the following figures.

FIG. 1 depicts a block diagram of a terminated entity detection system, in accordance with some embodiments.

FIG. 2 depicts a flowchart illustrating a terminated entity detection method, in accordance with some embodiments.

FIG. 3 depicts an example graph illustrating a terminated entity detection method that uses multiple attributes, in accordance with some embodiments.

FIG. 4 depicts an example process flow of a terminated entity detection method, in accordance with some embodiments.

FIG. 5 depicts an example algorithm of a terminated entity detection method, in accordance with some embodiment.

FIG. 6 depicts an example system with a machine readable storage media that includes instructions to perform terminated entity detection, in accordance with some embodiments.

FIG. 7 depicts a block diagram of an example terminated entity detection computing device in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor, and a non-transitory memory storing instructions is disclosed. The processor reads the instructions to receive a network activity dataset comprising data representative of network activity within a network environment and a plurality of data records. Each data record in the plurality of data records includes a set of attributes. The processor reads the instructions to generate a graph that links systems having a first role in the data representative of network activity and a subset of the plurality of data records. The processor reads the instructions to aggregate, for one or more of the systems having the first role in the data representative of network activity, feature information from the set of attributes for one or more data records in the subset of the plurality of data records in the graph. The processor reads the instructions to train a machine learning model based on the aggregated feature information derived from the graph to identify a flagged system having the first role in the data representative of network activity that is linked to a terminated entity. The processor reads the instructions to generate, using the trained machine learning model, a determination representing a likelihood that a respective system having the first role in the data representative of network activity is linked to the terminated entity. The terminated entity is excluded from having the first role. In response to receiving a determination that the likelihood of the respective system linked to the terminated entity exceeds a threshold, the processor reads the instructions to modify one or more permissions of the respective system for operating within the network environment.

In various embodiments, a computer-implemented method is disclosed. The computer-implemented method includes the steps of receiving a network activity dataset comprising (i) data representative of network activity within a network environment and (ii) a plurality of data records. Each data record in the plurality of data records includes a set of attributes. The computer-implemented method includes the step of generating a graph that links (i) systems having a first role in the data representative of network activity and (ii) a subset of the plurality of data records. The computer-implemented method includes the step of aggregating, for one or more of the systems having the first role in the data representative of network activity, feature information from the set of attributes for one or more data records in the subset of the plurality of data records in the graph, and training a machine learning model based on the aggregated feature information derived from the graph to identify a flagged system having the first role in the data representative of network activity that is linked to a terminated entity. The computer-implemented method includes generating, using the trained machine learning model, a determination representing a likelihood that a respective system having the first role in the data representative of network activity is linked to the terminated entity. The terminated entity is excluded from having the first role. The computer-implemented method further includes steps of, in response to receiving a determination that the likelihood of the respective system linked to the terminated entity exceeds a threshold, modifying one or more permissions of the respective system for operating within the network environment.

In various embodiments, a non-transitory computer-readable medium having instructions stored thereon is disclosed. The instructions, when executed by at least one processor, cause at least one device to perform operations, including receiving a network activity dataset comprising (i) data representative of network activity within a network environment and (ii) a plurality of data records. Each data record in the plurality of data records includes a set of attributes. The instructions cause the at least one device to perform operations including generating a graph that links (i) systems having a first role in the data representative of network activity and (ii) a subset of the plurality of data records. The instructions cause the at least one device to perform operations including aggregating, for one or more of the systems having the first role in the data representative of network activity, feature information from the set of attributes for one or more data records in the subset of the plurality of data records in the graph, and training a machine learning model based on the aggregated feature information derived from the graph to identify a flagged system having the first role in the data representative of network activity that is linked to a terminated entity. The instructions cause the at least one device to perform operations, including generating, using the trained machine learning model, a determination representing a likelihood that a respective system having the first role in the data representative of network activity is linked to the terminated entity. The terminated entity is excluded from having the first role. In response to receiving a determination that the likelihood of the respective system linked to the terminated entity exceeds a threshold, the instructions cause the at least one device to perform operations, including modifying one or more permissions of the respective system for operating within the network environment.

Furthermore, in the following, various embodiments are described with respect to methods and systems for detecting one or more terminated entities within an e-commerce environment. In various embodiments, the methods and systems described herein are capable of handling data represented as graphs having tens of millions of nodes, hundreds of millions of edges, and extensive node and edge features constructed using highly relational data. Using a graph neural network model that employs semi-supervised learning techniques to categorize sellers, even when there is a scarcity of labeled data (e.g., data labeling various seller nodes as risky seller nodes or safe seller nodes), by transmitting information from labeled to unlabeled nodes, relational information can be extracted from the graphs. Although some current networks use machine learning models for risk detection, these models have limitations when dealing with new users or offers with limited historical data, referred to as the cold start problem. Traditional machine learning models may also struggle to efficiently score a large volume of listings and may fail to leverage information about seller-product connections. As will be described below, attributes of sellers and items are embedded and encoded within node features to improve classification performance (e.g., classifying a seller as either a safe seller or a risky seller, by implementing a classification layer over the encoded embeddings on a seller node).

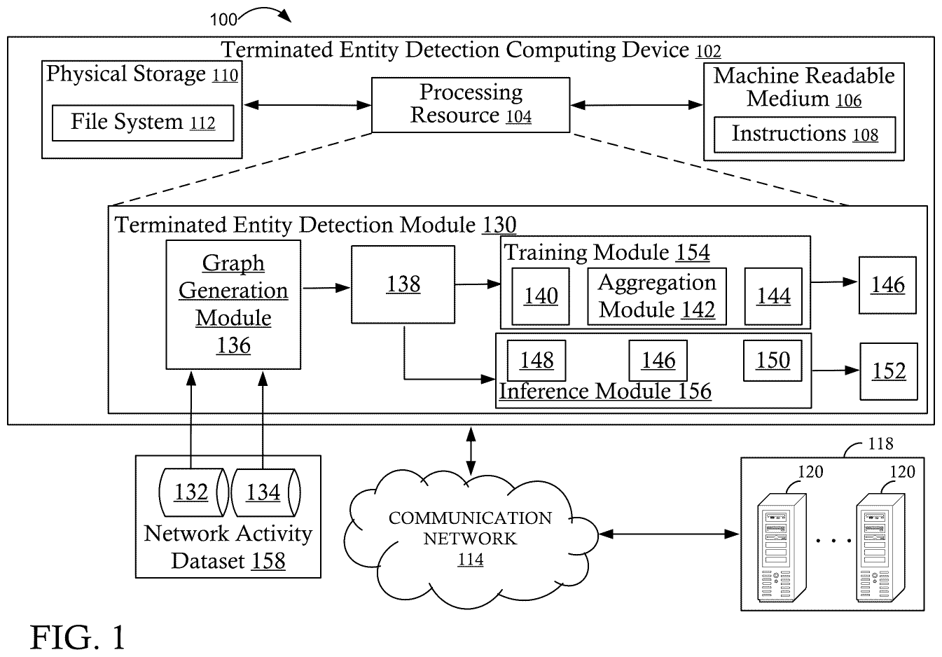

FIG. 1 depicts an example system 100 that provides automated detection of terminated entities within a network environment, in accordance with some embodiments. The system 100 includes a terminated entity detection computing device 102 that automatically flags users in a network environment that may be a terminated user or a proxy of a terminated user. The terminated entity detection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The terminated entity detection computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the terminated entity detection computing device 102, such as detecting users in a network environment that may be a terminated user or a proxy of a terminated user. The instructions 108 may include instructions for implementing one or more models. In some embodiments, and as will be described further herein below, the terminated entity detection computing device 102 may execute one or more models, processes, or algorithms, such as a machine learning model, deep learning model, statistical model, etc. (e.g., as implemented as machine readable instructions), to detect users in a network environment that may be a terminated user or a proxy of a terminated user.

The terminated entity detection computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the terminated entity detection computing device 102. In some implementations, physical storage 110 may be accessed as a block storage device.

In some cases, the terminated entity detection computing device 102 may also include a local file system 112 that may be implemented as a layer on top of the physical storage 110. For example, an operating system may be executing on the terminated entity detection computing device 102 (by virtue of the processing resource 104 executing certain instructions 108 related to the operating system) and the operating system may provide a file system 112 to store data on the physical storage 110.

The communication network 114 may enable communication between the terminated entity detection computing device 102 and a plurality of devices or systems over one or more network channels, illustrated as a network cloud. For example, in various embodiments, the terminated entity detection computing device 102 may be in communication with a web server, a cloud-based engine 118 including one or more processing devices 120 that may be provisioned for use, a database, a workstation, and/or any other suitable system or device. The terminated entity detection computing device 102 may similarly be in communication, either directly or indirectly, with one or more user computing devices operatively coupled over the communication network 114. The other computing systems may be similar to the terminated entity detection computing device 102, and may each include at least a processing resource and a machine readable medium.

The system architecture depicted in the terminated entity detection module 130 includes a training module 154 and an inference module 156. In some embodiments, the terminated entity detection module 130 runs on automation and may operate on a regular basis (e.g., daily, weekly, biweekly, monthly, etc.) such that risk scores are consistently generated for a network environment for inspection and to maintain the integrity and security of the network environment. An active user in the network environment may become a terminated user responsive to a determination that the seller has engaged in risky, harmful, and/or fraudulent activities, and/or other activities not satisfying one or more guidelines of the network environment. A terminated user may no longer have any permission within the network environment to engage in any network activities within the network environment (e.g., listing items for sale, selling items, receiving payment for items, processing refunds and returns of items, having access to a database listing items available within the network environment etc.). The term “terminated user” may also refer to user whose permissions to engage in network activities within the network environment are suspended, and/or whose activities on the network environment are temporarily being put on hold. Some terminated user may attempt to regain access to the network environment by masquerading as a new user. The term “terminated entity” as used herein is used interchangeably with the term “terminated user.” The terminated entity detection computing device 102 described herein detects active users that are in fact previously terminated users and/or are proxies or associates of such terminated users or terminated entities. In some embodiments, the terminated entity detection computing device 102 is able to detect active user that are engaged in or likely to be engaged in risky behavior in the network environment even when they may not be directly connected to a terminated user (e.g., the terminated entity detection computing device 102 may detect that the active user is likely to engage in risky behavior based on one or more characteristics with the user's inventory, signals from the user's on-boarding activities, location information of the user, offer information of the user, or other performance metrics of the user, etc.). In some embodiments, one or more of the systems having the first role in the data representative of network activity may refer to desktops, laptops, servers, mobile devices, or other devices associated with users performing a first role (e.g., as a seller in an e-commerce transaction) in the network environment. In some embodiments, the network environment also includes one or more users performing a second role (e.g., as a buyer in the e-commerce transaction, as a counterparty to the user and/or systems having the first role in the data representative of network activity) and/or one or more of the systems having the second role in the data representative of network activity.

“Anomaly detection,” as used in the context of this disclosure can be for example, fraud detection, in some embodiments. “Terminated entity detection,” as used in the context of this disclosure may refer to detecting one or more previously terminated or suspended users that have returned to the network environment masquerading as active users, detecting non-compliant or risky users who may be engaged in risky, dishonest, fraudulent or other activities that do not meet the standards of the network environment, and/or detecting items or offers that may be associated with such non-compliant users. In other words, the terminated entity detection computing device 102 flags non-compliant users, risky users, and/or detects low-quality listings and bad actors in network platforms. In some embodiments, the terminated entity detection computing device 102 evaluates network activity and may detect suspicious activity by new accounts and may thus protect user experience for other users in the network environment.

The cold start problem refers to the difficulty in providing accurate determinations due to limited or no historical data. For terminated entity detection, classifying new users as risky or not risky may be challenging, owing to the lack of user sales data. In some embodiments, new users are linked by the terminated entity detection computing device 102 to existing users based on the items they sell in a user-item graph, thus giving insights about the new user behavior based on the history of the existing users and the linked item(s). Additionally, different user on-boarding signals may be used as features for terminated entity detection and may capture correlations among varying entities and generate encoded embeddings. A Graph Neural Network (GNN) framework may address scalability issues by consolidating nodes. GNNs also tackle the cold start problem through message passing from existing entities to new ones. The terminated entity detection computing device 102 is capable of handling dynamic heterogeneous graphs (e.g., having tens of millions of nodes, hundreds of millions of edges, and extensive node and edge features) constructed using highly relational data. As will be described below, attributes of users and items are embedded and encoded within node features to improve classification performance (e.g., classifying a user as either a safe seller or a risky user, by implementing a classification layer over the encoded embeddings on a user node). In some embodiments, a graph neural network model employs semi-supervised learning techniques to categorize users, even when there is a scarcity of labeled data (e.g., data labeling various seller nodes as risky user nodes or safe user nodes), by transmitting information from labeled to unlabeled nodes.

In some embodiments, a network activity dataset 158 that includes data retrieved from an information store 132 for items (e.g., a database), and includes data retrieved from an information store 134 for users (e.g., a database), is provided to a graph generation module 136 to generate one or more user-item graphs 138. In user-item graphs 138, one or more users are represented as nodes, one or more items are also represented as nodes, and one or more attributes of the user or the items may also be represented as nodes. Edges connecting different nodes represent relationships between the nodes.

In some embodiments, the terminated entity detection module 130 receives the network activity dataset 158, which includes data representative of network activity within a network environment and a set of data records. Each data record in the set of data records includes a set of attributes. The data representative of network activity within the network environment may be located in the information store 132 and/or the information store 134. Similarly, the set of data records, each of which includes a set of attributes, may be located in the information store 132 and/or the information store 134. The network activity dataset 158 may include data showing which user is an active user, data about the network activities of active users (e.g., the volume of items sold by the user, the time period over which the items were sold, etc.), which user is a terminated user, data about the pre-termination network activities of the terminated users, and which users are new users without much network activity within the network environment.

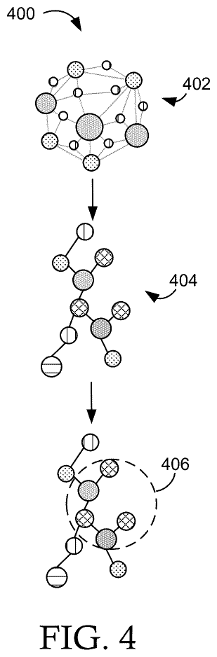

In some embodiments, the network activity dataset 158, the graph generation module 136 and/or the one or more user-item graphs 138 may be hosted at or be generated by a third-party platform. In some embodiments, the graph generation module 136 is integrated into and/or communicatively coupled to the terminated entity detection computing device 102 and/or the terminated entity detection module 103, within a local network environment of the terminated entity detection computing device 102. In some embodiments, diverse data pipelines are constructed to keep the network activity dataset 158 updated. A batch preparation module 140 may produce a sub-graph from the user-item graph 138, optionally at regular time intervals. Details about how the user-item graph is sampled to produce sub-graphs are provided below with reference to FIGS. 4, 5 and 6. In some embodiments, the sub-graph restricts subsequent computations to a fixed-size (e.g., a maximum fixed-size) neighborhood around each node, which may enhance batch training. In some embodiments, the batch preparation module 140 and an aggregation module 142 perform a pre-processing step (e.g., implemented by machine-readable instructions) within the training module 154. Features from the sub-graph are extracted by a featurization and aggregation module 142. Details about sub-graph featurization are also described below with reference to FIGS. 4, 5 and 6. Constructing and updating the user-item graph 138 can become computationally expensive. In some embodiments, scalability is improved for the terminated entity detection computing device 102 by using a distributed infrastructure running on three nodes.

The aggregation module 142 obtains raw feature matrices associated with one or more nodes of the sub-graphs, a raw label matrix for the nodes of the sub-graphs, a set of metapaths for the features (e.g., features represented by the raw feature matrices), and a set of metapaths for the labels (e.g., labels represented by the raw label matrix). The raw features are aggregated for each metapath in the set of metapaths for the features. Similarly, the raw labels are aggregated for each metapath in the set of metapaths for the labels. For example, the aggregation module 142 aggregates, for one or more of the systems having the first role in the data representative of network activity (e.g., one or more users represented by users nodes), feature information from the set of attributes for one or more data records (e.g., items, offers, location information) in the subset of the set of data records in the graph. The output of the two aggregation steps is collected to form semantic matrices. In some embodiments, performance may be enhanced by incorporating labels (e.g., risky sellers) as supplementary inputs. In some embodiments, labels for risky users are represented in a one-hot format, which are then propagated through various metapaths to produce a sequence of matrices. In some embodiments, these matrices depict the label distribution of the corresponding metapath in the sub-graphs. In some embodiments, specific features are generated and then stored to be used by a GNN model refinement module 144. For example, feature information from the set of attributes for one or more data records in the subset of the plurality of data records is aggregated using a layered network.

In some embodiments, after the pre-processing by aggregation module 142 above, the GNN model refinement module 144 executes (e.g., by implementing machine-readable instructions), for each training epoch, feature projection of the semantic matrices, followed by semantic fusion (e.g., transformer-based semantic fusion). In some embodiments, the feature projection step is a multi-level feature projection step to map semantic vectors or matrices into the same data space (e.g., transforming semantic vectors or matrices from various higher-dimensional spaces into the same lower-dimensional space).

In some embodiments, the GNN model refinement module 144 includes a multi-layer perception block having a normalization layer, a non-linear layer, and a dropout layer placed between two sequential linear layers that is used for each metapath for feature projection. Semantic fusion is used on the output of the feature projection step to generate a final embedding vector for each node in the subgraph. In some embodiments, a transformer-based semantic fusion module may be used to calculate attentions between semantic pairs of the semantic vectors derived from the output of the feature projection step. In some embodiments, another multi-layer perception is used to generate a prediction regarding the type of node (e.g., risky user or not a risky user). The node classification result is then used to compute a loss function and parameters of the neural network are updated. Following an assessment of the loss function, parameters associated with a neural network that demonstrates superior performance on validation data is selected and stored as model parameters 146. For example, the GNN model refinement module 144 trains a machine learning model based on the aggregated feature information derived from the graph (e.g. a sub-graph generated by the batch preparation module 140) to identify a flagged system (e.g., a risky user, and/or a previously terminated user masquerading as a different active user) having a first role (e.g., a seller) in the data representative of network activity that is linked to a terminated entity (e.g., a previously terminated user). In some embodiments, a comprehensive model encompassing a dataset of users is developed based on the information store 132 and the information store 134. In some embodiments, the dataset was divided into two segments: a training dataset that includes a majority of the users, and a validation dataset comprising the remaining users. Sub-graph sampling is used to generate sub-graphs for each user, and various sub-graphs are organized into batches. In some embodiments, to provide that the validation set remains uncontaminated by any form of data leakage, a seed flag is provided for each user node. Only the nodes that were part of the training set have the flag set to true to prevent any overlap or contamination between the training and validation datasets.

In some embodiments, there is dynamical sampling of the edges between nodes for every epoch to analyze the diversity of edges. In accordance with a determination that the edges in a particular epoch lack sufficient diversity, the types of edges that are lacking in the particular epoch are replenished in the next epoch. For example, the graph that links the systems having the first role (e.g., sellers) and the subset of the plurality of data records (e.g., items, offers, locations, etc.) is generated by dynamically adapting, for each system having the first role (e.g., each seller), a number of connections (e.g., edges) between a respective system having the first role (e.g., a seller) and the subset of the plurality of data records (e.g., items, offers, locations, etc.).

The terminated entity detection module 130 also includes an inference module 156. In some embodiments, the inference module 156 performs regular (e.g., daily) updates of a graph database 148 by utilizing several data pipelines to maintain real-time accuracy and relevancy of data such that the most current data is available within the inference module 156. For example, the graph database 148 may use a batch preparation pipeline, which operates on a regular schedule to manage the data batches, storing them into specific storage buckets for future retrieval and use. In some embodiments, the inference pipeline reads the data batches from the storage buckets (e.g., containing, for example, newly updated seller characteristics, item characteristics) and uses the model parameters 146 from the trained GNN model 144 to generate a score (e.g., from a scoring unit 150) that reflects a likelihood of fraudulent or harmful activities associated with or linked to a terminated entity. For example, the inference module 156 generates, using the trained machine learning model (e.g., having the model parameters 146), a determination representing a likelihood that a respective system having the first role in the network activity dataset 158 is linked to the terminated entity. The terminated entity is excluded from having the first role. The inference module 156 filters and singles out the top potentially risky users based on the risk scores to generate a list 152 of risky users. In some embodiments, the list 152 of user is then forwarded for use in one or more processes to maintain the integrity of the network environment by assessing and mitigating potential risks. In some embodiments, the network environment may conduct a real-time validation of flagged users. For example, when a user is flagged, the flagged user may be reviewed based on standard operating procedures of the network environment and subsequent action may be initiated, if necessary. The type of action taken may include termination, suspension, or sales being temporarily put on hold, depending on the results of the validation process, such that necessary measures are taken to maintain the integrity of the network environment. For example, in response to receiving a determination that the likelihood of the respective system linked to the terminated entity exceeds a threshold, one or more permissions of the respective system for operating within the network environment are modified (e.g., permissions of the user to engage in network activities within the network environment are terminated or suspended).

In some embodiments, different Graph Neural Network (GNN) models may be used to implement the systems and methods described herein (e.g., Relational Graph Convolutional Network (RGCN), Graph Attention Network (GAT), GraphSAGE, Hierarchical Graph Transformer (HGT), and SeHGNN). There are two primary classifications of Heterogeneous Graph Neural Networks (HGNNs): metapaths methods (e.g., SeHGNN) and metapath-free methods. Metapath-based methods extract and incorporate the same semantic structural information, while metapath-free methods concurrently capture both structural and semantic information. Hierarchical attention computation within multi-layer networks and ongoing neighbor aggregation in each epoch may lead to increased complexity and computational demand and may hinder the application of HGNNs to larger-scale heterogeneous graphs. Various performance metrics such as accuracy, precision, recall, and/or F-Beta score may be used to evaluate different GNN models using the same dataset (e.g., using a five-fold cross-validation method on the five GNN models listed above). In some embodiments, the average F-Beta score may be used as the main comparison criterion, given its balanced consideration of both precision and recall. In some embodiments, more importance may be given to recall (beta>1) to reduce the chance of missing risky users. In some embodiments, the implemented GNN includes an SeHGNN.

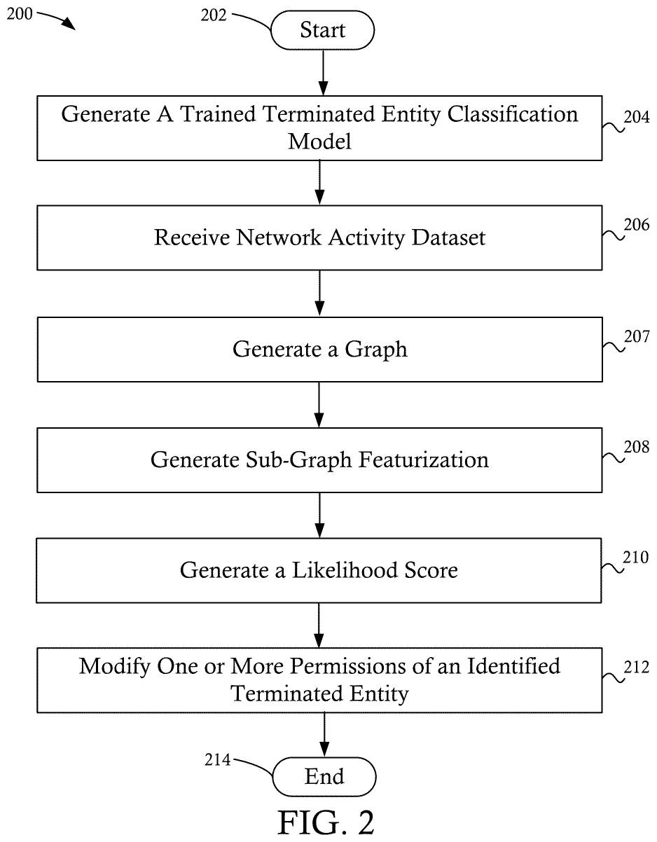

FIG. 2 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 2 may be implemented in the form of executable instructions stored on a machine readable media and executed by a processing resource and/or in the form of electronic circuitry. For example, aspects of the method may be described below as being performed by a terminated entity detection module 130, an example of which may be the terminated entity detection module 130 running on a hardware processing resource 104 of the terminated entity detection computing device 102 described above. Additionally, other aspects of the method described below may be described with reference to other elements shown in FIG. 1 for non-limiting illustration purposes.

FIG. 2 depicts a flowchart illustrating a terminated entity detection method 200 in accordance with some embodiments. A terminated entity detection method 200 starts block 202 and continues to block 204, where a trained terminated entity classification model is generated. For example, a trained terminated entity classification model may be generated based on aggregated feature information derived from a graph to identify a flagged system having a first role in data representative of network activity that is linked to a terminated entity, as discussed in more detail about with respect to FIG. 1. At block 206, a network activity dataset is received, such as a network activity dataset comprising data representative of network activity within a network environment and a plurality of data records. Each data record in the plurality of data records includes a set of attributes. At block 207, a graph that links systems having a first role in the data representative of network activity and a subset of the plurality of data records is generated. In some embodiments, block 207 may be performed by and/or may include aspects or steps of graph generation module 136. At block 208, sub-graph featurization is generated. For example, sub-graph featurization includes aggregating, for one or more of the systems having the first role in the data representative of network activity, feature information from the set of attributes for one or more data records in the subset of the plurality of data records in the graph. In some embodiments, block 208 may be performed by and/or may include aspects or steps of aggregation module 142. At block 210, a likelihood score is generated. For example, the likelihood score may be generated by using the trained machine learning model to make a determination representing a likelihood that a respective system having the first role in the data representative of network activity is linked to the terminated entity. The terminated entity is excluded from having the first role. In some embodiments, block 210 may be performed by and/or may include aspects or steps of inference module 156. At block 212, the method 200 modifies one or more permissions of an identified terminated entity. For example, in response to receiving a determination that the likelihood of the respective system linked to the terminated entity exceeds a threshold, one or more permissions of the respective system is modified for operating within the network environment. The method 200 ends at block 214.

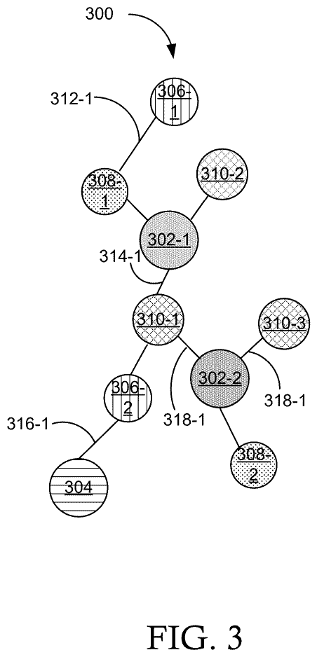

FIG. 3 is an example graph 300 illustrating a graph as used in the terminated entity detection method 200 discussed above, in accordance with some embodiments. A heterogeneous graph 300 illustrated in FIG. 3 has diverse nodes, such as nodes representing a user, an item, an offer, a location, etc., and each node is characterized by an associated feature vector. In some embodiments, each node may include both numeric and non-numeric features, and both types of features are vectorized to generate a node feature vector for each node type. A connection is established (e.g., directly connected by an edge, such as an edge 312-1, an edge 314-1, etc.) between a user node and an item node if the item is or has been a part of the user's inventory, regardless of a current status (e.g., active or inactive) of the item. The graph 300 (e.g., a user-item graph) also includes nodes related to the items offered by the user, such as a brand and product type of one or more items. For example, a first user node 302 is connected to a first item node 310-1 via a first edge or connection 314-1. A user node is also connected to a corresponding offer node if the offer node exists. In some embodiments, offer nodes may be characterized by the price proposed by the user, along with other details of the user's item. For example, a third user node 304 is connected to an offer node 306-2. In some embodiments, location nodes may store city and state location of the users and are linked to respective user nodes. For example, the second user node 302-2 is connected to a location node 308-2. In some embodiments, a user node may also be connected to nodes of device information, and/or personal particulars. In some embodiments, the feature vector of a user node may encapsulate one or more aspects such as user description, offer listing quality, etc., while the feature vector of an item node may capture one or more aspects, such as, for example, item title, brand, product type, etc. The feature vector of an offer node may incorporate one or more aspects, such as offer price, offer date, etc., and the feature vector of a location node may include one or more of: city, state, and/or country. Although using certain personal information can be useful for data modelling in the terminated entity detection computing device 102, in order to adhere to privacy guidelines, any sensitive information is suitably encoded before being vectorized to be fed to the model. For example, the graph that links the systems having the first role in the data representative of network activity (sellers) and the subset of the plurality of data records (e.g., items, offers, locations, etc.) includes a graph having multiple nodes. Each node is associated with selected attributes (e.g., item, location, offer, inventory information, quality of listing information, a user's performance metrics, etc.) from the set of attributes.

In some embodiments, the edges (e.g., all the edges) in the graph 300 are bi-directional and unweighted. The graph 300 is a heterogeneous graph due to the different nature of nodes in the graph 300 (e.g., user node, item node, offer node, location node etc.). The graph 300 is structurally linked via varying edge types, contingent on the node types. For example, the edge 312-1 is an edge type that links a location node with an offer node, edge 314-1 links a user node with an item node, edge 316-1 links a user node with an offer node, and edges 318-1 and 318-2 link a user node with two user attribute nodes (e.g., features from user onboarding signals, user performance metrics, user offering in a catalog, etc.). In some embodiments, these edge types delineate the structural relations between nodes, and may signify the complex interplay between users and their corresponding items. In some embodiments, the semantic relationship among nodes may be captured from the attribute features inherent in the node types. In some embodiments, each item is represented by creating embeddings of item description, optionally in conjunction with other item particulars such as price, returns and cancellations, etc., at the item level. In some embodiments, the nodes in the graph 300 help to capture the semantic relation between various node types and edge types. For example, the graph 300 may model relational data, which may be helpful in detecting intricate risk patterns inherent in interactions on a particular platform (e.g., in e-commerce transactions on an e-commerce environment or network platform). In some embodiments, heterogeneous Graph Neural Networks (HGNNs) may encapsulate rich semantic information, and leverage relationships between users, products, and listings to identify risky entities at scale. In some embodiments, within the context of node classification, labeled and unlabeled data are vertices in the graph 300. In some embodiments, a learning algorithm classifies labeled data as one category, and unlabeled data as another. Predictions are then made on the vertices of the unlabeled class (e.g., to classify the unlabeled class). In some embodiments, the graph 300 illustrated in FIG. 3 is a sub-group generated by sub-sampling a much larger sell-item graph. For example, graphs that link sellers (e.g., systems having the first role in the data representative of network activity) and the subset of the set of data records (e.g., items, offers, location, etc.) are generated by under-sampling, via heterogenous graph sampling, for each seller (e.g., a system having the first role in the data representative of network activity), the subset of the plurality of data records (e.g., items, offers, location, etc.).

FIG. 4 is an example process flow of a terminated entity detection method in accordance with some embodiments. A process flow 400 in FIG. 4 starts by obtaining a user-item graph 402. In some embodiments, obtaining the user-item graph 402 includes generating the user-item graph 402 using one or more datasets, and/or receiving the user-item graph 402 from another source. In some embodiments, the one or more datasets include a network activity dataset having data representative of network activity within a network environment and a set of data records. In some embodiments, each data record in the plurality of data records includes a set of attributes. Data representative of network activity within a network environment may include transaction data associated with network activities in a network environment (e.g., sellers listing items for sale, buyers purchasing items listed for sale, cancellations of sales transaction, and/or the returns of sold items). The set of data records may include records associated with an item for sale, product information, price, brand, offer information, attribute information pertaining to users, whether a user has been terminated (e.g., as a result of engaging in risky behavior), data from on-boarding of users, size of the user's inventory, and/or other information of the users. In some embodiments, generating the user-item graph 402 includes linking systems having a first role in the data representative of network activity and a subset of the set of data records. For example, systems having a first role in the data representative of network activity may include systems associated with active users, new users, or users that have been flagged or terminated (e.g., no longer active) due to risky behavior. The subset of the set of data records may include items in the user's inventory, location information associated with the user, and information relating to the items.

In some embodiments, the user-item graph 402 is constructed from datasets derived from data collected through one or more data pipelines. For example, each data pipeline may include ingesting raw data from data source(s), transforming the raw data and moving the transformed raw data into a data store. In some embodiments, to maintain data quality (e.g., reducing inaccuracies or gaps in data about users, products, offers, etc.), the database used to generate the user-item graph (e.g., the graph database) is refreshed at a regular cadence so that new data can be introduced and/or old data can be updated. For example, the graph database may be kept up to date by regular data ingestion tasks (e.g., via dataproc cron jobs). In some embodiments, a solitary graph is maintained in the graph database, allowing easy integration of new users or items, due to perpetual connections between new nodes and pre-existing ones. In some embodiments, the user-item graph 402 may encompass billions of nodes and edges, such that executing training and inference on the entire graph 402 or the entire dataset may not be feasible. In some embodiments, the number of nodes for each node type (e.g., user node, item node, offer node, location node, etc.) may not be uniform. For example, item nodes and offer nodes may dominate over user nodes.

In some embodiments, interconnections between users in the user-item graph 402 may be leveraged for risk detection. For example, users may be interconnected through common entities. The user nodes can be analyzed for patterns that are characteristic of risk cases, to identify potential risky users. In some embodiments, risk may be identified through item entities. For example, users may be intricately linked through shared product entities, extending beyond the mere items themselves. Signals of potential risk emanating from other entities help in identifying patterns that may pose a threat. These patterns are then collated at the user node. Such patterns may allow for a comprehensive understanding of not just the items being sold, but also the broader connections and interactions that may impact a user's risk profile.

In some embodiments, in the process flow 400, sub-sampling of the user-item graph 402 generates a sub-graph 404. The graph 300 illustrated in FIG. 3 is an example of a sub-graph generated from the seller-item graph by sub-sampling.

In some embodiments, Heterogeneous Graph Sampler may facilitate sampling nodes based on a specified sample number, which may facilitate sufficiently representing each node type. The magnitude of the sampled graph may be regulated using parameters like the number of hops. For example, the graph size of the sub-graph increases with the number of hops. In some embodiments, the heterogenous graph sampling method involves creating sub-graphs based on stratified sampling of each edge type, which may be useful in examples when each user may be connected to a large number of items, as the sampling may capture both item nodes and user nodes. In some embodiments, heterogenous graph sampling may offer the advantage of sampling without bias toward the node types having the largest number of nodes. For example, a user-item graph may be dominated by item nodes. Some item nodes (e.g., high-degree nodes) may have a very high degree of connections to other nodes (e.g., user nodes, offer nodes, etc.) and may give rise to issues when aggregating features for user nodes (e.g., neighbor sampling may over-represent high-degree nodes because such nodes serve as neighbor nodes to many other nodes). General graph-based approaches may tend to emphasize, sample or recommend popular sellers or products due to their high connectivity in the graph. This may result in overlooking niche or lesser-known options (e.g., low-degree nodes) that may be a better fit and/or provide better information for detecting risky users. Incorporating techniques such as diversity-aware algorithms or incorporating user preferences (e.g., user-specified preferences) may help in capturing diversity in user, item, and offer data. A sub-sampling strategy that balances processing time with information loss is thus desired. In some embodiments, a heterogenous graph sampling method that under-samples item nodes is used. For example, the method may dynamically adapt the sample size for a given node by using an adjustable or variable sample variance. This reduces information loss and also helps with the processing time

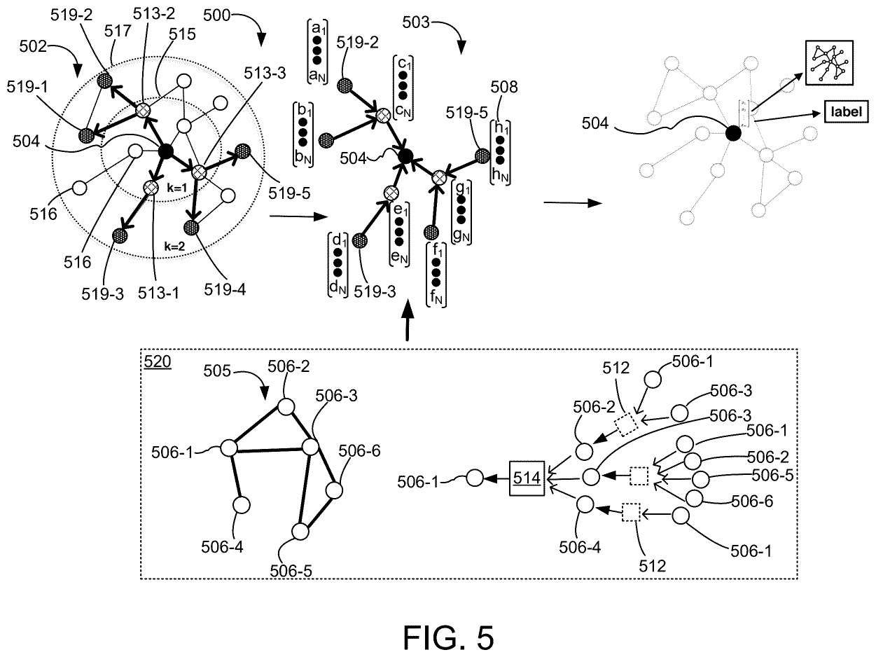

In the process flow 400, a graph neural network algorithm is used to process the sub-graph 404 to detect one or more linkages (e.g., a linkage 406) between users in the sub-graph 404. Details of how the graph neural network algorithm is used to detect the one or more linkages are described with reference to FIG. 5.

FIG. 5 is an example algorithmic flow 500 of a terminated entity detection method in accordance with some embodiment. An example algorithmic flow 500 starts with a portion 502 of a seller-item graph prior to any sub-sampling. A first circle 515 demarcates all neighboring nodes of a target node 504 that are one hop (e.g., k=1) away from the target node 504 (e.g., the nodes circumscribed within the first circle 515). A second circle 517 demarcates all neighboring nodes of a target node 504 that are two hops (e.g., k=2) away from the target node 504 (e.g., the nodes circumscribed within the second circle 517 and outside of the first circle 515). The sub-sampling process selects the three hatched nodes 513-1, 513-2, and 513-3 that are one hop away from the target node 504, and the unshaded nodes (e.g., nodes 516) are not sub-sampled to be part of the sub-graph. Similarly, the five dark gray nodes 519-1, 519-2, 519-3, 519-4, and 519-5, two hops away from the target node 504 are sub-sampled to form part of the sub-graph.

The middle panel of the algorithmic flow 500 shows a sub-graph 503, in which the unselected nodes are removed, and do not form part of the sub-graph 503. A vector 508 is computed for each of the nodes in the sub-graph 503. The arrows show various metapaths from the different nodes in the sub-graph 503 to the target node 504. In some embodiments, Simple and Efficient Heterogeneous Graph Neural Networks (SeHGNN) is used to represent the target node 504 by aggregating feature information from neighboring nodes. For example, neighbor aggregation may be simplified using a mean aggregator that uses a single-layer structure with extended metapaths to broaden the information collected for the target node. In some embodiments, simplified neighbor aggregation is performed at a pre-processing stage to generate a set of feature matrices for various (e.g., all) metapaths in a sub-graph. Examples of various metapaths may include: User-Item-User, User-ItemBrand-Item-User, User-Offer-Item-User, User-City-User, etc. For example, aggregating, for one or more of user nodes (e.g., corresponding to systems having the first role in the data representative of network activity), feature information from the set of attributes for one or more data records (e.g., items, brand, offer, city, etc.) in the subset of the set of data records in the graph. Such an approach may differ from traditional GNNs that utilize shared convolution layers throughout the graph, and/or those that implement attention mechanisms. Simple SeHGNN model frameworks may omit nodes that do not have any features, which may result in information loss. For example, the feature information from the set of attributes for one or more data records in the subset of the plurality of data records is aggregated by representing a respective system having the first role in the data representative of network activity (e.g., a user) using features from selected neighboring data records (e.g., items, offers, and location) within the subset of the plurality of data records that encapsulate both structural and semantic properties of the selected neighboring data records.

In some embodiments, the SeHGNN model is modified so that nodes without any features can still be used (e.g., incorporated into one or more metapaths) as paths for extending a neighborhood around a respective node. Such an approach may result in a better recall at detecting fraudulent users due to the additional information provided on paths that include nodes without features (e.g., nodes have missing feature representations). For example, brand nodes may have missing feature representations because new brands that are added to a user-item graph may not have a vector representation. As another example, a location node (e.g., a city node) may have missing feature representation because the city may not yet be in the database, or the city may not correspond to an actual city. For example, the graph that links the systems having the first role (e.g., users) and the subset of the plurality of data records (e.g., items, offers, location) is generated by connecting one or more data records in the subset of the plurality of data records that are without features.

In some embodiments, SeHGNN may perform a one-time aggregation instead of iterative procedures, and such one-time aggregation may improve (e.g., may significantly improve) the model's efficiency with respect to training and inference, enhancing scalability of the approach. In some embodiments, a lightweight mean aggregator and pre-computing neighbor aggregation may simplify the process and may also eliminate repetitive aggregation, resulting in an efficient and robust framework.

Inset 520 illustrates an example aggregate feature propagation using an example input graph 505 having six nodes: 506-1, 506-2, 506-3. 506-4, 506-5, and 506-6. The layered network depicted on the right of inset 520 illustrates both a single-layer network and a two-layer network. Setting the node 506-1 in the input graph 505 as the target node, there are three neighboring nodes to the target node 506-1: the node 506-2, the node 506-3, and the node 506-4, which are arranged to the right of the target node 506-1 in the layered network. Feature information from these three neighboring nodes is passed into the neural network 514 to be aggregated to represent the target node 506-1. Each of the three neighborhood nodes 506-2, 506-3, and 506-4 have their own neighboring nodes. For example, for the node 506-2, there are two neighboring nodes, nodes 506-1 and 506-3. For the node 506-3, there are four neighboring nodes: node 506-1, 506-2, 506-5, and 506-6. For the node 506-4, there is one neighboring node: node 506-1. In some embodiments, when the features are aggregated using a two layer system, the features from the second-degree neighboring nodes of the target node 506-1 are aggregated through respective neural networks 512, which are denoted with dotted lines in FIG. 5. In some embodiments, when the features are aggregated using a single-layer system, the features from the second-degree neighboring nodes of the target node 506-1 are not fused or aggregated by the neural networks 512. Rather, the paths (e.g., 506-1 to 506-2, 506-3 to 506-2, 506-1 to 506-3 etc.) are fused or aggregated only at the neural network 514.

Utilization of a single-layer structure with long metapaths may facilitate the expansion of the sampling space within the sub-graph to gather more thorough contextual information through various connections between sellers. These connections could be represented by metapaths linking users who share common selling items, are located in the same city, and/or sell similar brands or product types. The design of these extended metapaths is specifically crafted through multiple iterations and message aggregations from different metapaths to best represent and exploit these connections. In some embodiments, the neural network 514 incorporates a transformer-based module for semantic fusion (e.g., a complex operation that recognizes the semantic relationships between different features, not mere addition or multiplication of features), which merges features (e.g., semantic feature vectors) from various metapaths and optionally learns mutual attention between pairs of semantic vectors by employing a softmax normalization to compute respective mutual attention weight to produce the final embedding vector for each node. Such a final embedding vector may effectively amalgamate diverse information into a comprehensive representation.

In some embodiments, following feature propagation of various nodes through the topology of the sub-graph 503, the target node 504 (e.g., a user node) may obtain a comprehensive perspective on structural and semantic characteristics surrounding the target node 504. In some embodiments, the risky seller detection task may be reformulated into a node classification problem, with labels being applied exclusively to user nodes, and the labels being classified as either “risky user” or “non-risky user.” In some embodiments, the user-item graph 502 and the sub-graph 503 may include highly imbalanced data, where risky users constitute a small percentage of the total user base. In some embodiments, a Synthetic Minority Over-sampling Technique (SMOTE) designed for graphs may be used in the synthetic creation of user nodes, mirroring the characteristics of the original. For example, the graph that links the systems having the first role in the data representative of network activity (e.g., the users) and the subset of the plurality of data records (e.g., items, offers, locations, etc.) is generated by balanced sub-graph sampling that includes both systems having the first role in the data representative of network activity (e.g., non-risky users) and one of more systems that are terminated entities (e.g., risky users or terminated users). In some embodiments, a softmax layer is used as the classification layer that assists in identifying potential risky users.

In some embodiments, further potential enrichment to the systems and methods described herein may include integration of additional signals correlated with user performance, such as order history, refunds, and returns, etc. Incorporating these factors may provide a more comprehensive understanding of a user's overall performance, thereby enhancing the robustness of the model and contributing to the precision of its predictions. In some embodiments, temporal graph algorithms may be incorporated. Given the dynamic nature of the data being examined, these algorithms, specifically designed to process temporal features, may offer novel insight and potentially augment the model's performance. In some embodiments, explainability functionalities may be constructed on top of Graph Neural Network (GNN) algorithms to explain how these complex models make decisions, thereby increasing their transparency and trustworthiness—a crucial aspect in many applications. In some embodiments, transforming nodes into low-dimensional embeddings (e.g., in feature projection) may result in a loss of interpretability. In some embodiments, the systems and methods described herein may be augmented by leveraging generative AI with graph search retrieval systems to extract new patterns from seller entities, potentially revealing novel relationships and dependencies that might have been overlooked in a more traditional analysis, which may provide more accurate and nuanced predictions about user behavior, providing a richer understanding of the underlying dynamics.

It will be appreciated that terminated entity detection as disclosed herein, particularly on large datasets having millions or billions of items and user nodes, is only possible with the aid of computer-assisted machine-learning algorithms and techniques, such as graph neural networks such as SeHGNN. In some embodiments, machine learning processes, including SeHGNN are used to perform operations that cannot practically be performed by a human, either mentally or with assistance, such as sub-graph generation, feature aggregation, feature projection, and semantic fusion. It will be appreciated that a variety of machine learning techniques can be used alone or in combination to generate a prediction to be used in terminated entity detection.

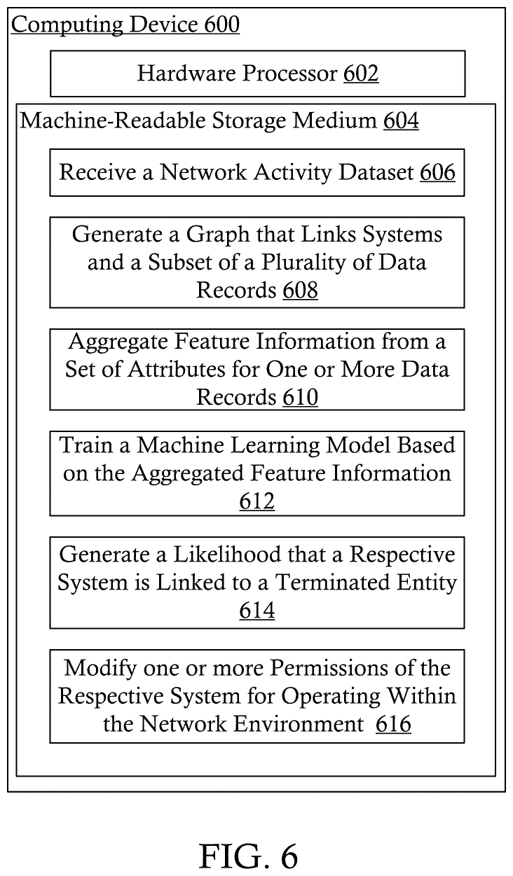

FIG. 6 depicts example system 600 that includes non-transitory, machine readable media 604 encoded with example instructions executable by processing resource 602. In some implementations, the system 600 may be useful for implementing aspects of the terminated entity detection module 130 of FIG. 1 or for performing aspects of method 200 of FIG. 2. For example, the instructions encoded on machine readable media 604 may be included in instructions 108 of FIG. 1. In some implementations, functionality described with respect to FIG. 1 may be included in the instructions encoded on machine readable media 604.

The processing resources 602 may include a microcontroller, a microprocessor, central processing unit core(s), an ASIC, an FPGA, and/or other hardware device suitable for retrieval and/or execution of instructions from the machine readable media 604 to perform functions related to various examples. Additionally or alternatively, the processing resources 602 may include or be coupled to electronic circuitry or dedicated logic for performing some or all of the functionality of the instructions described herein.

The machine readable media 604 may be any medium suitable for storing executable instructions, such as RAM, ROM, EEPROM, flash memory, a hard disk drive, an optical disc, or the like. In some example implementations, the machine readable media 604 may be a tangible, non-transitory medium. The machine readable media 604 may be disposed within the system 600, in which case the executable instructions may be deemed installed or embedded on the system. Alternatively, the machine readable media 604 may be a portable (e.g., external) storage medium, and may be part of an installation package.

As described further herein below, the machine readable media 604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 6.

With reference to FIG. 6, the machine readable media 604 includes instructions 606-616. Instructions 606, when executed, cause the processing resource 602 to receive a network activity dataset including data representative of network activity within a network environment and a plurality of data records, wherein each data record in the plurality of data records includes a set of attributes. Instructions 608, when executed, cause the processing resource 602 to generate a graph that links systems having a first role in the data representative of network activity and a subset of the plurality of data records. In some embodiments, instructions 608, may be executed or performed by and/or may include aspects or steps of graph generation module 136. Instructions 610, when executed, cause the processing resource 602 to aggregate for one or more of the systems having the first role in the data representative of network activity, feature information from the set of attributes for one or more data records in the subset of the plurality of data records in the graph. In some embodiments, instructions 610 may be executed or performed by and/or may include aspects or steps of aggregation module 142. Instructions 612, when executed, cause the processing resource 602 to train a machine learning model based on the aggregated feature information derived from the graph to identify a flagged system having the first role in the data representative of network activity that is linked to a terminated entity. Instructions 614, when executed, cause the processing resource 602 to generate, using the trained machine learning model, a determination representing a likelihood that a respective system having the first role in the data representative of network activity is linked to the terminated entity. The terminated entity is excluded from having the first role. In some embodiments, instructions 614 may be executed or performed by and/or may include aspects or steps of inference module 156. In response to receiving a determination that the likelihood of the respective system linked to the terminated entity exceeds a threshold, instructions 616, when executed, cause the processing resource 602 to modify one or more permissions of the respective system for operating within the network environment.

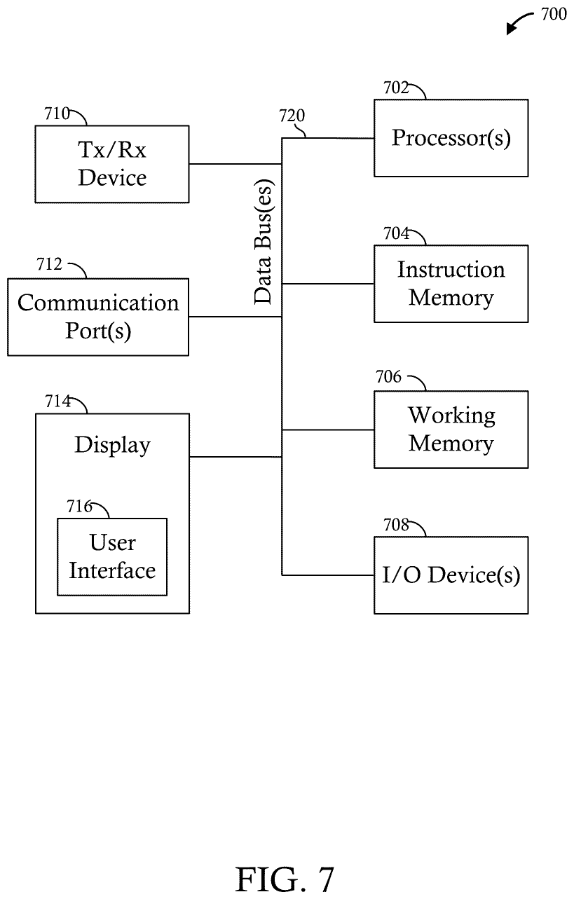

FIG. 7 illustrates a block diagram of a computing device 700, in accordance with some embodiments. Although FIG. 7 is described with respect to certain components shown therein, it will be appreciated that the elements of the computing device 700 may be combined, omitted, and/or replicated. In addition, it will be appreciated that additional elements other than those illustrated in FIG. 7 may be added to the computing device.

As shown in FIG. 7, the computing device 700 may include one or more processing resources 702, instruction memory 704, working memory 706, input/output devices 708, transceiver 710, communication port(s) 712, display 714, optional location device 718, and/or any other suitable elements each operatively coupled to one or more data buses 720. The data buses 720 allow for communication among the various components. The data buses 720 may include wired, or wireless, communication channels.

The one or more processing resources 702 may include any processing circuitry operable to control operations of the computing device 700. In some embodiments, the one or more processing resources 702 include one or more distinct processors, each having one or more cores (e.g., processing circuits). Each of the distinct processors may have the same or different structure. The one or more processing resources 702 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor (such as a complex instruction set computer (CISC) microprocessor), a reduced instruction set computing (RISC) microprocessor, and/or a very long instruction word (VLIW) microprocessor, or other processing device. The one or more processing resources 702 may also be implemented by a controller, a microcontroller, an application specific integrated circuit (ASIC), a field programmable gate array (FPGA), a programmable logic device (PLD), etc.

In some embodiments, the one or more processing resources 702 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 704 may store instructions that are accessed (e.g., read) and executed by at least one of the one or more processing resources 702. For example, the instruction memory 704 may be a non-transitory, computer-readable storage medium such as a read-only memory (ROM), an electrically erasable programmable read-only memory (EEPROM), flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 702 may perform a certain function or operation by executing code, stored on the instruction memory 704, embodying the function or operation. For example, the one or more processing resources 702 may execute code stored in the instruction memory 704 to perform one or more of any function, method, or operation disclosed herein.

Additionally, the one or more processing resources 702 may store data to, and read data from, the working memory 706. For example, the one or more processing resources 702 may store a working set of instructions to the working memory 706, such as instructions loaded from the instruction memory 704. The one or more processing resources 702 may also use the working memory 706 to store dynamic data created during one or more operations. The working memory 706 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 704 and working memory 706, it will be appreciated that the computing device 700 may include a single memory unit that operates as both instruction memory and working memory. Further, although embodiments are discussed herein including non-volatile memory, it will be appreciated that computing device 700 may include volatile memory components in addition to at least one non-volatile memory component.

In some embodiments, the instruction memory 704 and/or the working memory 706 includes an instruction set in the form of a file for executing various methods, such as methods for terminated entity detection, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 702.

The input/output devices 708 may include any suitable device that allows for data input or output. For example, the input/output devices 708 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 710 and/or the communication port(s) 712 allow for communication with a network, such as the communication network 114 of FIG. 1. For example, if the communication network 114 of FIG. 1 is a cellular network, the transceiver 710 allows communications with the cellular network. In some embodiments, the transceiver 710 is selected based on the type of the communication network 114 the computing device 700 will be operating in. The one or more processing resources 702 are operable to receive data from, or send data to, a network, such as the communication network 114 of FIG. 1, via the transceiver 710.

The communication port(s) 712 may include any suitable hardware, software, and/or combination of hardware and software that is capable of coupling the computing device 700 to one or more networks and/or additional devices. The communication port(s) 712 may be arranged to operate with any suitable technique for controlling information signals using a desired set of communications protocols, services, or operating procedures. The communication port(s) 712 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 712 allows for the programming of executable instructions in the instruction memory 704. In some embodiments, the communication port(s) 712 allow for the transfer (e.g., uploading or downloading) of data, such as machine learning model training data.

In some embodiments, the communication port(s) 712 couples the computing device 700 to a network. The network may include local area networks (LAN) as well as wide area networks (WAN), including without limitation, Internet, wired channels, wireless channels, communication devices, including telephones, computers, wire, radio, optical and/or other electromagnetic channels, and combinations thereof, including other devices and/or components capable of/associated with communicating data. For example, the communication environments may include in-body communications, various devices, and various modes of communications, such as wireless communications, wired communications, and combinations of the same.

In some embodiments, the transceiver 710 and/or the communication port(s) 712 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 714 may be any suitable display, and may display the user interface 216. The user interfaces 216 may enable user interaction with the terminated entity detection computing device 102. For example, the user interface 216 may be a user interface for an application of a network environment operator that allows a user to view and interact with the operator's website. In some embodiments, a user may interact with the user interface 216 by engaging the input/output devices 708. In some embodiments, the display 714 may be a touchscreen, where the user interface 216 is displayed on the touchscreen.

The display 714 may include a screen such as, for example, a Liquid Crystal Display (LCD) screen, a light-emitting diode (LED) screen, an organic LED (OLED) screen, a movable display, a projection, etc. In some embodiments, the display 714 may include a coder/decoder, also known as Codecs, to convert digital media data into analog signals. For example, the visual peripheral output device may include video Codecs, audio Codecs, or any other suitable type of Codec.

In some embodiments, the computing device 700 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices, such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 700 may be a computer, a workstation, a laptop, a server such as a cloud-based server, or any other suitable device. In some embodiments, the computing device 700 is a server that includes one or more processing units, such as one or more graphical processing units (GPUs), one or more central processing units (CPUs), and/or one or more processing cores. The computing device 700 may, in some embodiments, execute one or more virtual machines. In some embodiments, processing resources (e.g., capabilities) of the computing device 700 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a network activity dataset comprising (i) data representative of network activity within a network environment and (ii) a plurality of data records, wherein each data record in the plurality of data records includes a set of attributes;
generate a graph that links (i) systems having a first role in the data representative of network activity and (ii) a subset of the plurality of data records;
aggregate, for one or more of the systems having the first role in the data representative of network activity, feature information from the set of attributes for one or more data records in the subset of the plurality of data records in the graph;
train a machine learning model based on the aggregated feature information derived from the graph to identify a flagged system having the first role in the data representative of network activity that is linked to a terminated entity;
generate, using the trained machine learning model, a determination representing a likelihood that a respective system having the first role in the data representative of network activity is linked to the terminated entity, wherein the terminated entity is excluded from having the first role; and
in response to receiving a determination that the likelihood of the respective system linked to the terminated entity exceeds a threshold, modify one or more permissions of the respective system for operating within the network environment.

2. The system of claim 1, wherein the trained machine learning model comprises a graph neural network model.

3. The system of claim 1, wherein the graph that links the systems having the first role in the data representative of network activity and the subset of the plurality of data records is generated by under-sampling, via heterogenous graph sampling, for each system having the first role in the data representative of network activity, the subset of the plurality of data records.

4. The system of claim 3, wherein the graph that links the systems having the first role and the subset of the plurality of data records is generated by connecting one or more data records in the subset of the plurality of data records that are without features.

5. The system of claim 3, wherein the graph that links the systems having the first role and the subset of the plurality of data records is generated by dynamically adapting, for each system having the first role, a number of connections between a respective system having the first role and the subset of the plurality of data records.

6. The system of claim 1, wherein the graph that links the systems having the first role in the data representative of network activity and the subset of the plurality of data records is generated by balanced sub-graph sampling that includes both systems having the first role in the data representative of network activity and one of more systems that are terminated entities.

7. The system of claim 1, wherein the feature information from the set of attributes for one or more data records in the subset of the plurality of data records is aggregated by representing a respective system having the first role in the data representative of network activity using features from selected neighboring data records within the subset of the plurality of data records that encapsulate both structural and semantic properties of the selected neighboring data records.

8. The system of claim 7, wherein the feature information from the set of attributes for one or more data records in the subset of the plurality of data records is aggregated using a layered network.

9. The system of claim 1, wherein the graph that links the systems having the first role in the data representative of network activity and the subset of the plurality of data records comprises a graph having multiple nodes, wherein each node is associated with selected attributes from the set of attributes.

10. A computer-implemented method, comprising:
receiving a network activity dataset comprising (i) data representative of network activity within a network environment and (ii) a plurality of data records, wherein each data record in the plurality of data records includes a set of attributes;
generating a graph that links (i) systems having a first role in the data representative of network activity and (ii) a subset of the plurality of data records;
aggregating, for one or more of the systems having the first role in the data representative of network activity, feature information from the set of attributes for one or more data records in the subset of the plurality of data records in the graph; and
training a machine learning model based on the aggregated feature information derived from the graph to identify a flagged system having the first role in the data representative of network activity that is linked to a terminated entity; and
generating, using the trained machine learning model, a determination representing a likelihood that a respective system having the first role in the data representative of network activity is linked to the terminated entity, wherein the terminated entity is excluded from having the first role; and
in response to receiving a determination that the likelihood of the respective system linked to the terminated entity exceeds a threshold, modifying one or more permissions of the respective system for operating within the network environment.

11. The computer-implemented method of claim 10, wherein generating the graph linking systems having the first role in the data representative of network activity and the subset of the plurality of data records comprises under-sampling, via heterogenous graph sampling, for each systems having the first role in the data representative of network activity, the subset of the plurality of data records.

12. The computer-implemented method of claim 11, wherein generating the graph linking systems having the first role and the subset of the plurality of data records comprises connecting one or more data records in the subset of the plurality of data records that are without features.

13. The computer-implemented method of claim 11, wherein generating the graph linking systems having the first role and the subset of the plurality of data records comprises dynamically adapting, for each systems having the first role, a number of connections between a respective system having the first role and the subset of the plurality of data records.

14. The computer-implemented method of claim 10, wherein generating the graph linking systems having the first role in the data representative of network activity and the subset of the plurality of data records comprises balanced sub-graph sampling that includes both systems having the first role in the data representative of network activity and one of more systems that are terminated entities.

15. The computer-implemented method of claim 10, wherein aggregating the feature information from the set of attributes for one or more data records in the subset of the plurality of data records comprises representing a respective system having the first role in the data representative of network activity using features from selected neighboring data records within the subset of the plurality of data records that encapsulate both structural and semantic properties of the selected neighboring data records.

16. The computer-implemented method of claim 15, wherein aggregating the feature information from the set of attributes for one or more data records in the subset of the plurality of data records comprises using a layered network.

17. A non-transitory computer readable medium having instructions stored thereon, wherein the instructions, when executed by at least one processor, cause at least one device to perform operations comprising:
receiving a network activity dataset comprising (i) data representative of network activity within a network environment and (ii) a plurality of data records, wherein each data record in the plurality of data records includes a set of attributes;
generating a graph that links (i) systems having a first role in the data representative of network activity and (ii) a subset of the plurality of data records;
aggregating, for one or more of the systems having the first role in the data representative of network activity, feature information from the set of attributes for one or more data records in the subset of the plurality of data records in the graph; and
training a machine learning model based on the aggregated feature information derived from the graph to identify a flagged system having the first role in the data representative of network activity that is linked to a terminated entity; and
generating, using the trained machine learning model, a determination representing a likelihood that a respective system having the first role in the data representative of network activity is linked to the terminated entity, wherein the terminated entity is excluded from having the first role; and
in response to receiving a determination that the likelihood of the respective system linked to the terminated entity exceeds a threshold, modify one or more permissions of the respective system for operating within the network environment.

18. The non-transitory computer readable medium of claim 17, wherein generating the graph that links the systems having the first role in the data representative of network activity and the subset of the plurality of data records comprises under-sampling, via heterogenous graph sampling, for each systems having the first role in the data representative of network activity, the subset of the plurality of data records.

19. The non-transitory computer readable medium of claim 18, wherein generating the graph that links the systems having the first role and the subset of the plurality of data records comprises connecting one or more data records in the subset of the plurality of data records that are without features.

20. The non-transitory computer readable medium of claim 17, wherein aggregating the feature information from the set of attributes for one or more data records in the subset of the plurality of data records comprises representing a respective system having the first role in the data representative of network activity using features from selected neighboring data records within the subset of the plurality of data records that encapsulate both structural and semantic properties of the selected neighboring data records.
